(19) United States
(12) Patent Application Publication
(10) Pub. No.: US 2024/0039001 A1
(43) Pub. Date: Feb. 1, 2024

(54) ELECTROCHEMICAL CELLS WITH REINFORCED CURRENT COLLECTORS, AND METHODS OF PRODUCING THE SAME

(71) Applicant: 24M Technologies, Inc., Cambridge, MA (US)

(72) Inventors: Yuki KUSACHI, Burlington, MA (US); Naoki OTA, Lexington, MA (US); Junzheng CHEN, Concord, MA (US)

(21) Appl. No.: 18/375,654

(22) Filed: Oct. 2, 2023

Related U.S. Application Data
(63) Continuation of application No. PCT/US2022/022382, filed on Mar. 29, 2022.
(60) Provisional application No. 63/249,863, filed on Sep. 29, 2021.
(60) Provisional application No. 63/167,741, filed on Mar. 30, 2021.

(51) Int. Cl. H01M 4/66; H01M 4/04; H01M 4/139

(52) U.S. Cl. CPC H01M 4/667; H01M 4/043; H01M 4/0404; H01M 4/139; H01M 2004/021

(57) ABSTRACT

Embodiments described herein relate to electrochemical cells and electrodes with reinforced current collectors. In some embodiments, an electrode can include a current collector and an electrode material disposed on a first side of the current collector. A reinforcing layer can be disposed on a second side of the current collector. The reinforcing layer can have a modulus of elasticity sufficient to reduce the amount of stretching incident on the current collector during operation of the electrode. In some embodiments, a polymer film can be disposed on the reinforcing material. In some embodiments, the electrode can further include an adhesive polymer disposed between the reinforcing material and the polymer film. In some embodiments, the reinforcing material can have a thickness of less than about 10 μm. In some embodiments, the reinforcing layer can include an adhesive polymer.

### CROSS REFERENCE TO RELATED APPLICATIONS

This application claims priority and benefit of U.S. Provisional Application Nos. 63/167,741 filed Mar. 30, 2021 and 63/249,863 filed Sep. 29, 2021, both entitled “Electrochemical Cells with Reinforced Current Collectors and Methods of Producing the Same”, the disclosures of which are hereby incorporated by reference in their entirety.

### TECHNICAL FIELD

Embodiments described herein relate to electrodes and electrochemical cells with reinforced current collectors, and methods of producing the same.

### BACKGROUND

Embodiments described herein relate generally to electrochemical cells with reinforced current collectors. During operation, components of electrochemical cells can expand and contract. This expansion and contraction can be due to temperature fluctuations in the cell as well as mechanical stimuli. Electrochemical materials can be included in the components that expand and contract. Current collectors coupled to the electrode materials can also expand and contract. Expansion and contraction of current collector material can cause wrinkles, gaps, discontinuities, and compressed portions to appear in electrode material coupled to current collectors. Such defects can also appear in the current collector itself. These defects can hamper battery life, making portions of the electrode material unusable. Even current collector materials with high tensile strength or high modulus of elasticity can still deform inelastically causing inelastic deformation in the electrodes over time. Engineered current collector materials with a high modulus of elasticity can be expensive. A system that reduces formation of such defects in a cell can preserve electrochemical cell performance.

### SUMMARY

Embodiments described herein relate to electrochemical cells and electrodes with reinforced current collectors. In some embodiments, an electrode can include a current collector and an electrode material disposed on a first side of the current collector. A reinforcing layer can be disposed on a second side of the current collector. The reinforcing layer can have a modulus of elasticity sufficient to reduce the amount of stretching incident on the current collector during operation of the electrode. In some embodiments, a polymer film can be disposed on the reinforcing material. In some embodiments, the electrode can further include an adhesive polymer disposed between the reinforcing material and the polymer film. In some embodiments, the reinforcing material can have a thickness of less than about 10 μm. In some embodiments, the reinforcing layer can include an adhesive polymer. In some embodiments, an adhesive polymer can be disposed between the reinforcing material and the current collector. In some embodiments, the adhesive polymer disposed between the reinforcing material and the current collector can include at least one of an elastomer and a crosslinked polymer.

### BRIEF DESCRIPTION OF THE DRAWINGS

FIG. 1 is a block diagram an electrode with a current collector reinforcement system, according to an embodiment.

FIG. 2 is an illustration of an electrode with a current collector reinforcement system, according to an embodiment.

FIGS. 3A-3B are illustrations of an electrode with a current collector reinforcement system, according to an embodiment.

FIGS. 4A-4B are illustrations of an electrode with a current collector reinforcement system, according to an embodiment.

FIGS. 5A-5B are illustrations of an electrode with a current collector reinforcement system, according to an embodiment.

FIG. 6 is an illustration of an electrode with a current collector reinforcement system, according to an embodiment.

FIGS. 7A-7B are illustrations of an electrode with a current collector reinforcement system, according to an embodiment.

FIGS. 8A-8B are illustrations of an electrode with a current collector reinforcement system, according to an embodiment.

FIG. 9 is an illustration of an electrochemical cell with a current collector reinforcement system, according to an embodiment.

FIG. 10 is a block diagram of a method of producing an electrode with a current collector reinforcement system.

### DETAILED DESCRIPTION

Embodiments described herein relate to electrodes and electrochemical cells with current collector reinforcement systems, and methods of producing the same. In some embodiments, electrochemical cells and electrodes can include current collectors with reinforcing materials coupled thereto. Reinforcing the current collectors can allow for construction of electrodes with thinner current collectors. This allows for less current collector material to be used and reduced cost. Additionally, the electrochemical cells with reinforced current collectors can potentially have a lower mass and increased energy and power density. In some embodiments, the electrochemical cells described herein can include a semi-solid cathode and/or a semi-solid anode. In some embodiments, the semi-solid electrodes described herein can be binderless and/or can use less binder than is typically used in conventional battery manufacturing. The semi-solid electrodes described herein can be formulated as a slurry such that the electrolyte is included in the slurry formulation. This is in contrast to conventional electrodes, for example calendered electrodes, where the electrolyte is generally added to the electrochemical cell once the electrochemical cell has been disposed in a container, for example, a pouch or a can.

In some embodiments, the electrode materials described herein can be a flowable semi-solid or condensed liquid composition. In some embodiments, a flowable semi-solid electrode can include a suspension of an electrochemically active material (anodic or cathodic particles or particulates), and optionally an electronically conductive material (e.g., carbon) in a non-aqueous liquid electrolyte. In some embodiments, the active electrode particles and conductive particles can be co-suspended in an electrolyte to produce a semi-solid electrode. In some embodiments, electrode materials described herein can include conventional electrode materials (e.g., including lithium metal).

Examples of electrodes, electrolyte solutions, and methods that can be used for preparing the same are described in U.S. Pat. No. 9,437,864 (hereafter “the '864 Patent”) filed Mar. 10, 2014, entitled “Asymmetric Battery Having a Semi-Solid Cathode and High Energy Density Anode,” the entire disclosure of which is incorporated herein by reference in its entirety. Additional examples of electrodes, electrolyte solutions, and methods that can be used for preparing the same are described in U.S. Pat. No. 9,484,569 (hereafter “the '569 Patent”), filed Mar. 15, 2013, entitled “Electrochemical Slurry Compositions and Methods for Preparing the Same,” U.S. Patent Publication No. 2016/0133916 (hereafter “the '916 Publication”), filed Nov. 4, 2015, entitled “Electrochemical Cells Having Semi-Solid Electrodes and Methods of Manufacturing the Same,” and U.S. Pat. No. 8,993,159 (hereafter “the '159 Patent”), filed Apr. 29, 2013, entitled “Semi-Solid Electrodes Having High Rate Capability,” the entire disclosures of which are hereby incorporated by reference herein.

In some embodiments, electrodes and electrochemical cells herein can include current collectors with reduced dimensions. In other words, the current collector can cover only a portion of the electrode material, to which the current collector is coupled. Examples of electrodes with current collectors covering only a portion of an adjacent electrode material are described in U.S. patent application Ser. No. 17/181,554 (hereafter “the '554 application”), filed Feb. 22, 2021, entitled “Electrochemical Cells with Electrode Material Coupled Directly to Film and Methods of Making the Same,” the entire disclosure of which is hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

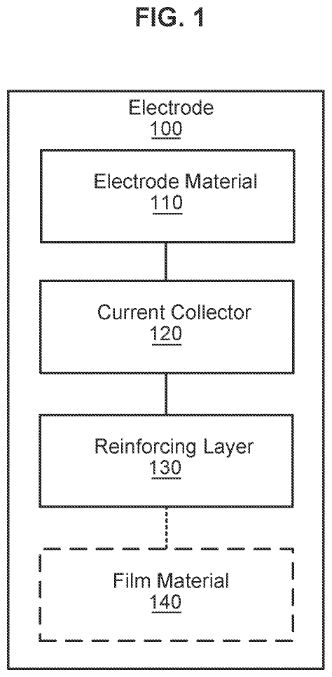

FIG. 1 is a block diagram of an electrode 100 with a current collector reinforcement system, according to an embodiment. As shown, the electrode 100 includes an electrode material 110 disposed on a first side of a current collector 120 and a reinforcing layer 130 disposed on a second side of the current collector 120, the second side opposite the first side. In some embodiments, the electrode 100 can include a film material 140 disposed on the reinforcing layer 130.

In some embodiments, the electrode material 110 can include an anode material. In some embodiments, the electrode material 110 can include a cathode material. In some embodiments, the electrode material 110 can include silicon. In some embodiments, the electrode material 110 can include at least one high-capacity anode material selected from silicon, bismuth, boron, gallium, indium, zinc, tin, antimony, aluminum, titanium oxide, molybdenum, germanium, manganese, niobium, vanadium, tantalum, iron, copper, gold, platinum, chromium, nickel, cobalt, zirconium, yttrium, molybdenum oxide, germanium oxide, silicon oxide, silicon carbide, any other high-capacity materials or alloys thereof, and any combination thereof. In some embodiments, the electrode material 110 can include silicon alloys, tin alloys, aluminum, titanium oxide, or any combination thereof. In some embodiments, the electrode material 110 can include any of the materials described in the '864 patent. In some embodiments, the electrode material 110 can include a semi-solid electrode material. In some embodiments, the electrode material 110 can be binderless.

In some embodiments, the electrode material 110 can have a thickness of at least about 50 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1,000 μm, at least about 1,100 μm, at least about 1,200 μm, at least about 1,300 μm, at least about 1,400 μm, at least about 1,500 μm, at least about 1,600 μm, at least about 1,700 μm, at least about 1,800 μm, or at least about 1,900 μm. In some embodiments, the electrode material 110 can have a thickness of no more than about 2,000 μm, no more than about 1,900 μm, no more than about 1,800 μm, no more than about 1,700 μm, no more than about 1,600 μm, no more than about 1,500 μm, no more than about 1,400 μm, no more than about 1,300 μm, no more than about 1,200 μm, no more than about 1,100 μm, no more than about 1,000 μm, no more than about 900 μm, no more than about 800 μm, no more than about 700 μm, no more than about 600 μm, no more than about 500 μm, no more than about 400 μm, no more than about 300 μm, no more than about 200 μm, or no more than about 100 μm. In some embodiments, the electrode material 110 can have a thickness of about 50 μm, about 100 μm, about 200 μm, about 300 μm, about 400 μm, about 500 μm, about 600 μm, about 700 μm, about 800 μm, about 900 μm, about 1,000 μm, about 1,100 μm, about 1,200 μm, about 1,300 μm, about 1,400 μm, about 1,500 μm, about 1,600 μm, about 1,700 μm, about 1,800 μm, about 1,900 μm, or about 2,000 μm.

In some embodiments, the electrode material 110 can include multiple layers. In some embodiments, the electrode material 110 can include a first layer with a first porosity and a second layer with a second porosity, the second porosity different from the first porosity. In some embodiments, the anode material 110 can include a first layer with a first energy density and a second layer with a second energy density, the second energy density different from the first energy density. Examples of electrodes with compositional gradients are described in U.S. Patent Publication No. 2019/0363351 (hereafter “the '351 publication”), filed May 24, 2019 and entitled, “High Energy-Density Composition-Gradient Electrodes and Methods of Making the Same,” the entire disclosure of which is hereby incorporated by reference in its entirety.

In some embodiments, the current collector 120 can be composed of copper, aluminum, titanium, or other metals that do not form alloys or intermetallic compounds with lithium, carbon, and/or coatings comprising such materials disposed on another conductor. In some embodiments, the current collector 120 can be made extra thin due to the extra support provided by the reinforcing layer 130. In some embodiments, the current collector 120 can have a thickness of less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, less than about 10 μm, less than about 9 μm, less than about 8 μm, less than about 7 μm, less than about 6 μm, less than about 5 μm, less than about 4 μm, less than about 3 μm, less than about 2 μm, or less than about 1 μm, inclusive of all values and ranges therebetween.

In some embodiments, the current collector 120 can include holes. Holes in the current collector 120 can further reduce the amount of current collector material included in the electrode 100. In some embodiments, the holes can be arranged in a mesh grid. In some embodiments, the holes can be punched into the current collector 120. In some embodiments, the current collector 120 can have a porosity (i.e., a percentage of the area of a surface of the current collector 120 taken up by holes), of at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90%. In some embodiments, the current collector 120 can have a porosity of no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10%.

Combinations of the above-referenced porosities of the current collector 120 are also possible (e.g., at least about 5% and no more than about 95% or at least about 30% and no more than about 50%), inclusive of all values and ranges therebetween. In some embodiments, the current collector 120 can have a porosity of about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95%.

Combinations of the above-referenced thicknesses of the electrode material 110 are also possible (e.g., at least about 50 μm and no more than about 2,000 μm or at least about 150 μm and no more than about 500 μm), inclusive of all values and ranges therebetween.

In some embodiments, the reinforcing layer 130 can have a tensile strength of at least about 400 MPa, at least about 450 MPa, at least about 500 MPa, at least about 550 MPa, at least about 600 MPa, at least about 650 MPa, at least about 700 MPa, or at least about 750 MPa. In some embodiments, the reinforcing layer 130 can have a tensile strength of no more than about 800 MPa, no more than about 750 MPa, no more than about 700 MPa, no more than about 650 MPa, no more than about 600 MPa, no more than about 550 MPa, no more than about 500 MPa, or no more than about 450 MPa. Combinations of the above-referenced tensile strengths of the reinforcing layer 130 are also possible (e.g., at least about 400 MPa and no more than about 800 MPa or at least about 500 MPa and no more than about 700 MPa), inclusive of all values and ranges therebetween. In some embodiments, the reinforcing layer 130 can have a tensile strength of about 400 MPa, about 450 MPa, about 500 MPa, about 550 MPa, about 600 MPa, about 650 MPa, about 700 MPa, about 750 MPa, or about 800 MPa.

In some embodiments, the reinforcing layer 130 can have a modulus of elasticity of at least about 50 GPa, at least about 100 GPa, at least about 150 GPa, at least about 200 GPa, at least about 250 GPa, at least about 300 GPa, at least about 350 GPa, at least about 400 GPa, at least about 450 GPa, at least about 500 GPa, at least about 550 GPa, at least about 600 GPa, at least about 650 GPa, at least about 700 GPa, at least about 750 GPa, at least about 800 GPa, at least about 850 GPa, at least about 900 GPa, or at least about 950 GPa. In some embodiments, the reinforcing layer 130 can have a modulus of elasticity of no more than about 1,000 GPa, no more than about 950 GPa, no more than about 900 GPa, no more than about 850 GPa, no more than about 800 GPa, no more than about 750 GPa, no more than about 700 GPa, no more than about 650 GPa, no more than about 600 GPa, no more than about 550 GPa, no more than about 500 GPa, no more than about 450 GPa, no more than about 400 GPa, no more than about 350 GPa, no more than about 300 GPa, no more than about 250 GPa, no more than about 200 GPa, no more than about 150 GPa, or no more than about 100 GPa. Combinations of the above-referenced moduli of elasticity of the reinforcing layer 130 are also possible (e.g., at least about 50 GPa and no more than about 1,000 GPa or at least about 400 GPa and no more than about 600 GPa), inclusive of all values and ranges therebetween. In some embodiments, the reinforcing layer 130 can have a modulus of elasticity of about 50 GPa, about 100 GPa, about 150 GPa, about 200 GPa, about 250 GPa, about 300 GPa, about 350 GPa, about 400 GPa, about 450 GPa, about 500 GPa, about 550 GPa, about 600 GPa, about 650 GPa, about 700 GPa, about 750 GPa, about 800 GPa, about 850 GPa, about 900 GPa, about 950 GPa, or about 1,000 GPa. In some embodiments, the reinforcing layer 130 can have a higher modulus of elasticity than the current collector 120.

In some embodiments, the reinforcing layer 130 can include sodium silicate, glass powder, ceramic powder, glass fibers, short glass fibers, long glass fibers, carbon nanotubes, carbon fibers, short carbon fibers, long carbon fibers, or any other suitable reinforcing material or combinations thereof. In some embodiments, the reinforcing layer 130 can include an adhesive material or a binder disposed therein. In some embodiments, the adhesive material can include an adhesive polymer. In some embodiments, the adhesive polymer can include a high strength adhesive polymer. In some embodiments, the reinforcing layer 130 can be coupled to the current collector 120 via an adhesive material. In other words, an adhesive material can be disposed between the reinforcing layer 130 and the current collector 120. In some embodiments, the adhesive material disposed between the reinforcing layer 130 and the current collector 120 can include a polymer adhesive or a high-strength polymer adhesive. In some embodiments, adhesion between the reinforcing layer 130 and the current collector 120 can further restrict stretching of the current collector 120. In some embodiments, the use of an adhesive either incorporated into the reinforcing layer 130 or disposed between the current collector 120 and the reinforcing layer 130 increase the collective tensile strength and modulus of elasticity of the reinforcing layer 130 and the current collector 120.

In some embodiments, the reinforcing layer 130 can partially or fully occupy void space in the current collector 120 left by the holes in the current collector 120. In some embodiments, the reinforcing layer 130 can have a thickness of at least about 1 μm, at least about 5 μm, at least about 10 μm, at least about 15 μm, at least about 20 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, at least about 75 μm, at least about 80 μm, at least about 85 μm, at least about 90 μm, or at least about 95 μm. In some embodiments, the reinforcing layer 130 can have a thickness of no more than about 100 μm, no more than about 95 μm, no more than about 90 μm, no more than about 85 μm, no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 20 μm, no more than about 15 μm, no more than about 10 μm, or no more than about 5 μm. Combinations of the above-referenced thicknesses of the reinforcing layer 130 are also possible (e.g., at least about 1 μm and no more than about 100 μm or at least about 40 μm and no more than about 40 μm), inclusive of all values and ranges therebetween. In some embodiments, the reinforcing layer 130 can have a thickness of about 1 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 40 μm, about 80 μm, about 85 μm, about 90 μm, about 95 μm, or about 100 μm.

In some embodiments, the film material 140 can form a portion of a pouch. In some embodiments, the film material 140 can be a first film material and can be coupled to a second film material to form the pouch. In some embodiments, the pouch can be vacuum sealed, such that the film material 140 applies a force to the reinforcing layer 130. This force can keep the reinforcing layer 130 coupled to the current collector 120 and prevent the reinforcing layer 130 from becoming detached from the current collector 120. In some embodiments, the film material 140 can provide further structural reinforcement to the reinforcing layer 130. In some embodiments, the film material can prevent peeling of the reinforcing layer 130. In some embodiments, the film material 140 can be coupled to the reinforcing layer 130 via an adhesive. In some embodiments, the film material 140 can be heat melted and laminated to the reinforcing layer 130.

In some embodiments, the film material 140 can include a three-layer structure, namely an intermediate layer sandwiched by an outer layer and an inner layer, wherein the inner layer is in contact with the electrodes and the electrolyte. For example, the outer layer can include a nylon-based polymer film. The inner layer can include a polypropylene (PP) polymer film, which can be corrosion-resistive to acids or other electrolyte and insoluble in electrolyte solvents. The intermediate layer can include of aluminum (Al) foil. This structure allows the pouch to have both high mechanical flexibility and strength.

In some embodiments, the outer layer of the film material 140 can include polymer materials such as polyethylene terephthalate (PET), polybutylene terephthalate (PBT), nylon, high-density polyethylene (HDPE), oriented polypropylene (o-PP), polyvinyl chloride (PVC), polyimide (PI), polysulfone (PSU), and any combinations thereof. In some embodiments, the intermediate layer of the film material 140 can include metal layers (foils, substrates, films, etc.) comprising aluminum (Al), copper (Cu), stainless steel (SUS), and their alloys or any combinations thereof. In some embodiments, the inner layer of the film material 140 can include materials such as cast polypropylene (c-PP), polyethylene (PE), ethylene vinylacetate (EVA), PET, Poly-vinyl acetate (PVA), polyamide (PA), acrylic adhesives, ultraviolet (UV)/electron beam (EB)/infrared (IR) curable resin, and any combinations thereof. In some embodiments, the film material 140 can include a non-flammable material, such as for example, polyether ether ketone (PEEK), polyethylene naphthalate (PEN), polyethersulfone (PES), PI, polyphenylene sulfide (PPS), polyphenylene oxide (PPO), and any combinations thereof. In some embodiments, the film material 140 can include a coating or a film of flame retardant additive material, such as flame-retardant PET. In some embodiments, the film material 140 includes a two-layer structure, namely an outer layer and an inner layer. In some embodiments, the outer layer can include PET, PBT, or other materials as described above. In some embodiments, the inner layer can include PP, PE, or other materials described above. In some embodiments, the film material 140 can include a water barrier layer and/or gas barrier layer. In some embodiments, the barrier layer can include a metal layer and/or an oxide layer. In some embodiments, it can be beneficial to include the oxide layer because oxide layers tend to be insulating and can prevent short circuits within the battery.

In some embodiments, the film material 140 can have a thickness of at least about 1 μm, at least about 5 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 110 μm, at least about 120 μm, at least about 130 μm, at least about 140 μm, at least about 150 μm, at least about 160 μm, at least about 170 μm, at least about 180 μm, or at least about 190 μm. In some embodiments, the film material 140 can have a thickness of no more than about 200 μm, no more than about 190 μm, no more than about 180 μm, no more than about 170 μm, no more than about 160 μm, no more than about 150 μm, no more than about 140 μm, no more than about 130 μm, no more than about 120 μm, no more than about 110 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 5 μm, or no more than about 1 μm.

Combinations of the above-referenced thicknesses of the film material are also possible (e.g., at least about 1 μm and no more than about 100 μm, or at least about 20 μm and no more than about 60 μm), inclusive of all values and ranges therebetween. In some embodiments, the film material 140 can have a thickness of about 1 μm, about 5 μm, about 10 μm, about 20 μm, about 30 μm, about 40 μm, about 50 μm, about 60 μm, about 70 μm, about 140 μm, about 90 μm, about 100 μm, about 110 μm, about 120 μm, about 130 μm, about 140 μm, about 150 μm, about 160 μm, about 170 μm, about 180 μm, about 190 μm, or about 200 μm.

In some embodiments, the electrode 100 can be part of an electrochemical cell. In some embodiments, the electrode 100 can be coupled to another electrode with a separator disposed therebetween to form an electrochemical cell.

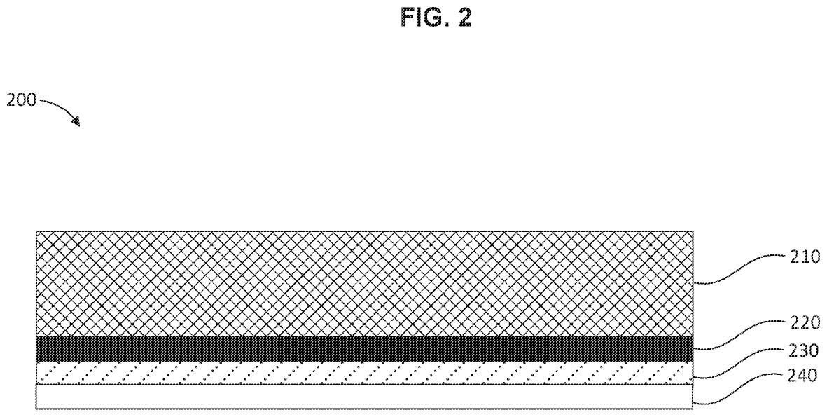

FIG. 2 is an illustration of an electrode 200 with a current collector reinforcement system, according to an embodiment. As shown, the electrode 200 includes an electrode material 210 disposed on a first side of a current collector 220 with a reinforcing layer 230 disposed on a second side of the current collector 220, the second side opposite the first side. A film material 240 is disposed on the reinforcing layer 230. In some embodiments, the electrode material 210, the current collector 220, the reinforcing layer 230, and the film material 240 can be the same or substantially similar to the electrode material 110, the current collector 120, the reinforcing layer 130, and the film material 140 respectively, as described above with reference to FIG. 1. Thus, certain aspects of the electrode material 210, the current collector 220, the reinforcing layer 230, and the film material 240 are not described in greater detail herein.

As shown, the film material 240 is disposed on an outside surface of the reinforcing layer 230. In some embodiments, the film material 240 and the reinforcing layer 230 can be combined into a single layer of reinforcing pouch material. In some embodiments, a single layer of material can provide both the function of contamination prevention and the function of structural reinforcement of the current collector 220. As shown, the reinforcing layer 230 is disposed on an outside surface of the current collector 220. In some embodiments, the reinforcing layer 230 and the current collector 220 can be combined into a single composite layer of conductive and reinforcing material.

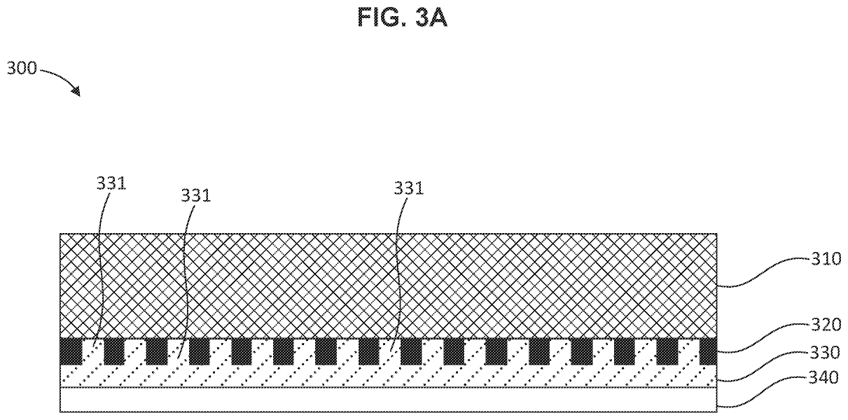

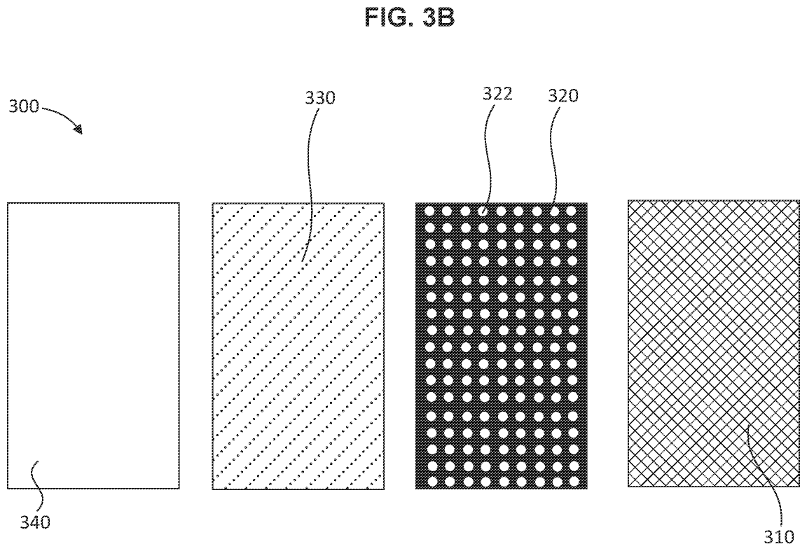

FIGS. 3A-3B are illustrations of an electrode 300 with a current collector reinforcement system, according to an embodiment. FIG. 3A shows a cross-sectional view of the electrode 300 while FIG. 3B shows an exploded view of the components of the electrode 300. As shown, the electrode 300 includes an electrode material 310 disposed on a first side of a current collector 320 with a reinforcing layer 330 disposed on a second side of the current collector 320, the second side opposite the first side. A film material 340 is disposed on the reinforcing layer 330. The current collector 320 includes holes 322 while the reinforcing material 330 includes protuberances 331 that penetrate the holes 322. In some embodiments, the electrode material 310, the current collector 320, the reinforcing layer 330, and the film material 340 can be the same or substantially similar to the electrode material 110, the current collector 120, the reinforcing layer 130, and the film material 140, as described above with reference to FIG. 1. Thus, certain aspects of the electrode material 310, the current collector 320, the reinforcing layer 330, and the film material 340 are not described in greater detail herein.

As shown, the holes 322 are arranged in a mesh grid configuration, with rows and columns running parallel to each other. In some embodiments, rows of the holes 322 can run parallel to each other while columns of the holes 322 are arranged in a staggered configuration. In some embodiments, columns of the holes 322 can run parallel to each other while rows of the holes 322 are arranged in a staggered configuration. In some embodiments, the holes 322 can be arranged to maximize the structural integrity of the current collector 320. In some embodiments, the holes 322 can further reduce wrinkling or other deformation of the electrode material 310 by allowing for excess portions of the electrode material 310 to at least partially penetrate the holes 322.

In some embodiments, the holes 322 can have diameters of at least about 1 μm, at least about 5 μm, at least about 10 μm, at least about 20 μm, at least about 30 μm, at least about μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the holes 322 can have diameters of no more than about 1,000 μm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, or no more than about 5 μm.

Combinations of the above-referenced diameters of the holes 322 are also possible (e.g., at least about 1 μm and no more than about 1,000 μm or at least about 50 μm and no more than about 100 μm), inclusive of all values and ranges therebetween. In some embodiments, the holes 322 can have diameters of about 1 μm, about 5 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1,000 μm. In some embodiments, the holes 322 can have uniform or substantially uniform diameters. In some embodiments, the holes 322 can have differing diameters. In some embodiments, the holes 322 can have a polydisperse diameter distribution.

As shown, the protuberances 331 of the reinforcing layer 330 fully penetrate the holes 322 to physically contact the electrode material 310. In some embodiments, the protuberances 331 of the reinforcing layer 330 can partially penetrate the holes 322. In some embodiments, a surface of the reinforcing material 330 adjacent to the current collector 320 can be flush with the current collector 320, such that substantially no portion of the reinforcing layer 330 penetrates into the holes 322. In other words, the protuberances 331 can be flat or the reinforcing layer 330 can be absent of the protuberances 331.

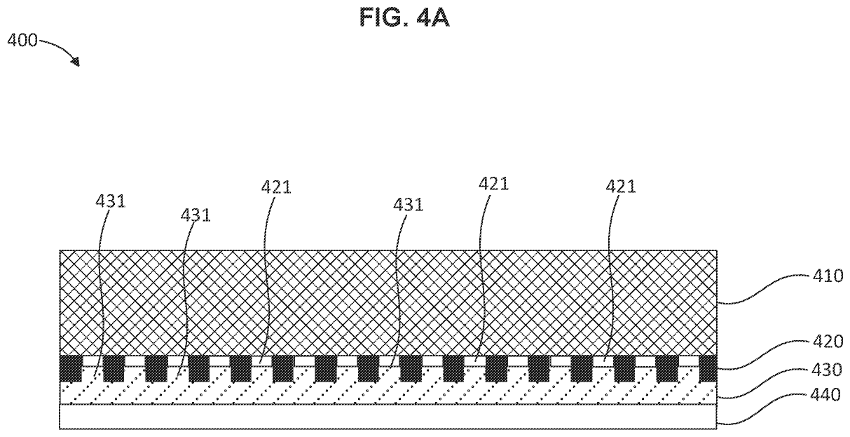

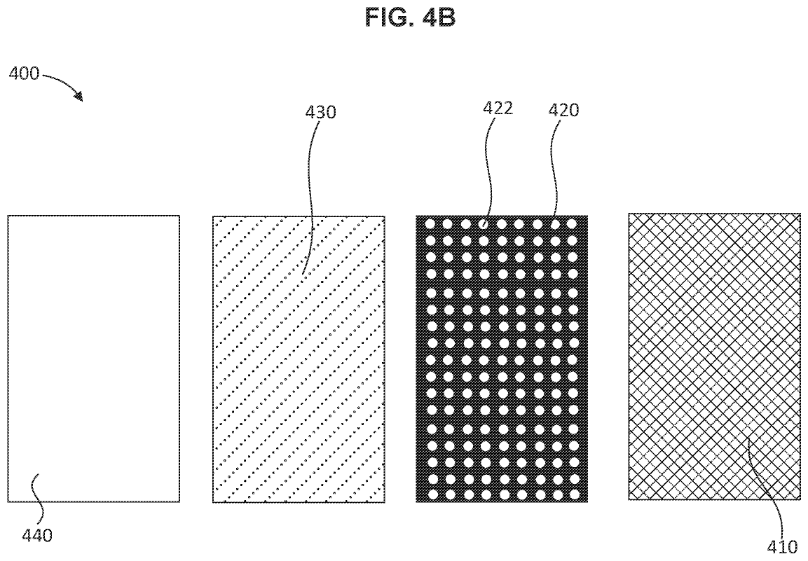

FIGS. 4A-4B are illustrations of an electrode 400 with a current collector reinforcement system, according to an embodiment. FIG. 4A shows a cross-sectional view of the electrode 400 while FIG. 4B shows an exploded view of the components of the electrode 400. As shown, the electrode 400 includes an electrode material 410 disposed on a first side of a current collector 420 with a reinforcing layer 430 disposed on a second side of the current collector 420, the second side opposite the first side. A film material 440 is disposed on the reinforcing layer 430. The current collector 420 includes holes 422 while the reinforcing material 430 includes protuberances 431 that penetrate the holes 422. In some embodiments, the electrode material 410, the current collector 420, the holes 422, the reinforcing layer 430, the protuberances 431, and the film material 440 can be the same or substantially similar to the electrode material 310, the current collector 320, the holes 322, the reinforcing layer 330, the protuberances 331, and the film material 340 respectively, as described above with reference to FIGS. 3A-3B. Thus, certain aspects of the electrode material 410, the current collector 420, the holes 422, the reinforcing layer 430, the protuberances 431, and the film material 440 are not described in greater detail herein.

As shown, the protuberances 431 of the reinforcing layer partially penetrate the holes 422, such that the protuberances 431 do not penetrate the entire thickness of the current collector 420. Void spaces 421 are shown between edges of the protuberances 431 and edges of the current collector 420. In some embodiments, the protuberances 431 can penetrate at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, or at least about 90% of the thickness of the current collector 420. In some embodiments, the protuberances 431 can penetrate no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10% of the thickness of the current collector 420.

Combinations of the above-referenced percentages of the thickness of the current collector 420 penetrated by the protuberances 431 are also possible (e.g., at least about 5% and no more than about 95% or at least about 30% and no more than about 60%), inclusive of all values and ranges therebetween. In some embodiments, the protuberances 431 can penetrate about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the thickness of the current collector 420.

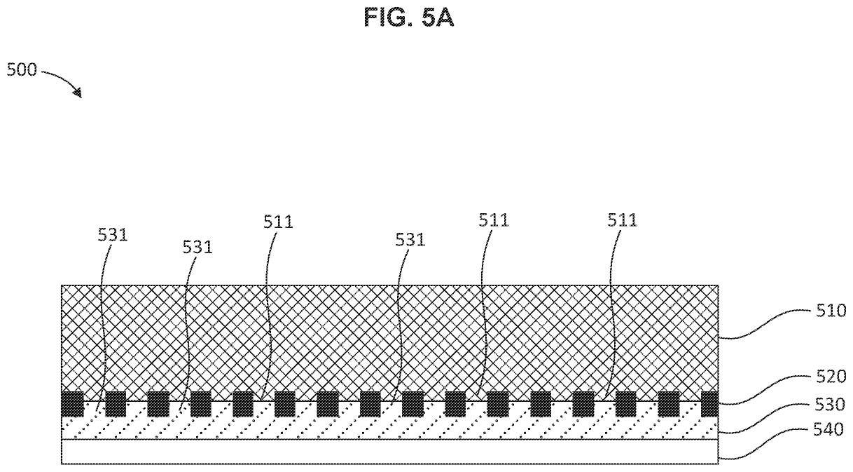

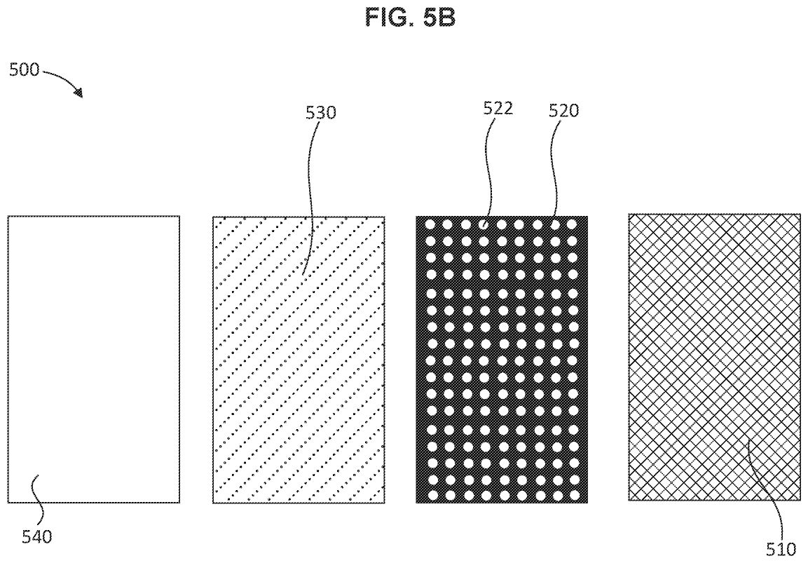

FIGS. 5A-5B are illustrations of an electrode 500 with a current collector reinforcement system, according to an embodiment. FIG. 5A shows a cross-sectional view of the electrode 500 while FIG. 5B shows an exploded view of the components of the electrode 500. As shown, the electrode 500 includes an electrode material 510 disposed on a first side of a current collector 520 with a reinforcing layer 530 disposed on a second side of the current collector 520, the second side opposite the first side. A film material 540 is disposed on the reinforcing layer 530. The current collector 520 includes holes 522 while the reinforcing material 530 includes protuberances 531 that penetrate the holes 522. The electrode material 510 also includes protuberances 511 that penetrate the holes 522. In some embodiments, the electrode material 510, the current collector 520, the holes 522, the reinforcing layer 530, the protuberances 531, and the film material 540 can be the same or substantially similar to the electrode material 410, the current collector 420, the holes 422, the reinforcing layer 430, the protuberances 431, and the film material 440, as described above with reference to FIGS. 4A-4B. Thus, certain aspects of the electrode material 510, the current collector 520, the holes 522, the reinforcing layer 530, the protuberances 531, and the film material 540 are not described in greater detail herein.

As shown, the protuberances 511 of the electrode material 510 and the protuberances 531 of the reinforcing layer 530 meet at points along the thickness of the current collector 520. In some embodiments, the meeting point of the protuberances 511 of the electrode material 510 and the protuberances 531 of the reinforcing layer 530 can be approximately at the middle of the thickness of the current collector 520. In some embodiments, the meeting point of the protuberances 511 of the electrode material 510 and the protuberances 531 of the reinforcing layer 530 can be at about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the thickness of the current collector 520, when measured from the surface of the current collector 520 adjacent to the reinforcing layer 530, inclusive of all values and ranges therebetween. In some embodiments, the meeting points between the protuberances 511 of the electrode material 510 and the protuberances 531 of the reinforcing layer 530 can be approximately homogeneous across all of the holes 520. In some embodiments, the meeting points between the protuberances 511 of the electrode material 510 and the protuberances 531 of the reinforcing layer 530 can be heterogeneous.

In some embodiments, the electrode material 510 can be coated onto the current collector 520 and the protuberances 511 can be created via portions of the electrode material 510 moving or flowing into the holes 522. In some embodiments, the electrode material 510 can include one or more binders. In some embodiments, the electrode material 510 can be binderless or substantially free of binder. In some embodiments, the electrode material 510 can be pressed onto the current collector 520 to squeeze portions of the electrode material 510 into the holes 522, thus creating the protuberances 511. In some embodiments, the electrode material 510 can include a semi-solid electrode material. In some embodiments, the electrode material 510 can be deposited onto the current collector via electrochemical deposition, vapor deposition, sputtering, or any other suitable deposition methods. In some embodiments, the electrode material 510 can include a high-capacity material. In some embodiments, the high-capacity material can include tin, silicon, antimony, aluminum, and/or titanium oxide. In some embodiments, the high-capacity material can include any of the high-capacity materials described in U.S. Patent publication no. 2019/0363351, filed May 24, 2019, entitled, “High Energy-Density Composition-Gradient Electrodes and Methods of Making the Same,” the disclosure of which is hereby incorporated by reference in its entirety.

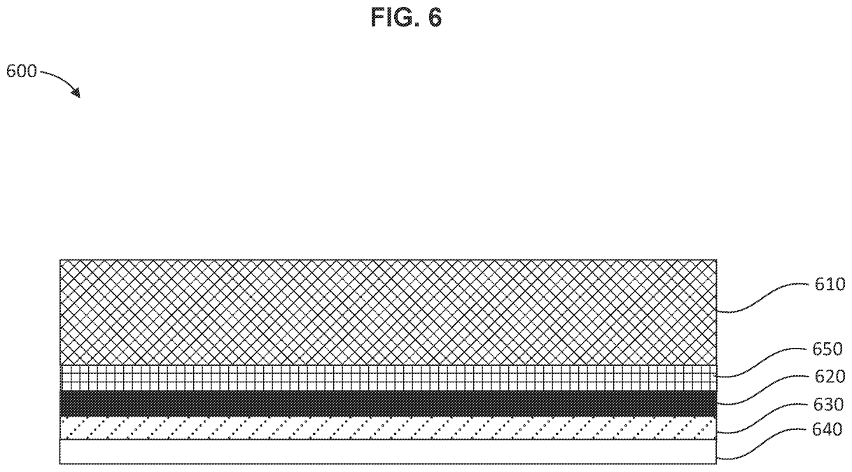

FIG. 6 is an illustration of an electrode 600 with a current collector reinforcement system, according to an embodiment. As shown, the electrode 600 includes an electrode material 610 and a lithium-containing layer 650 disposed on a first side of a current collector 620 with a reinforcing layer 630 disposed on a second side of the current collector 620, the second side opposite the first side. A film material 640 is disposed on the reinforcing layer 630. In some embodiments, the electrode material 610, the current collector 620, the reinforcing layer 630, and the film material 640 can be the same or substantially similar to the electrode material 110, the current collector 120, the reinforcing layer 130, and the film material 140 respectively, as described above with reference to FIG. 1. Thus, certain aspects of the electrode material 610, the current collector 620, the reinforcing layer 630, and the film material 640 are not described in greater detail herein.

In some embodiments, the lithium-containing layer 650 can be disposed in the electrode 600 for pre-lithiation. Systems and methods of pre-lithiation are described in U.S. Pat. No. 10,497,935 (hereafter “the '935 Patent”), filed Nov. 3, 2015, entitled “Pre-Lithiation of Electrode Materials in a Semi-Solid Electrode,” the entire disclosure of which is hereby incorporated by reference. In some embodiments, the loading of active material in the lithium-containing layer 650 can be lower than in the electrode material 610.

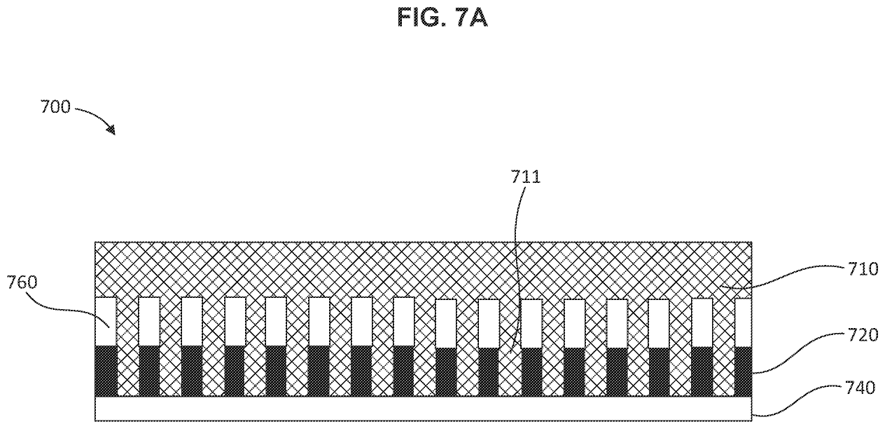

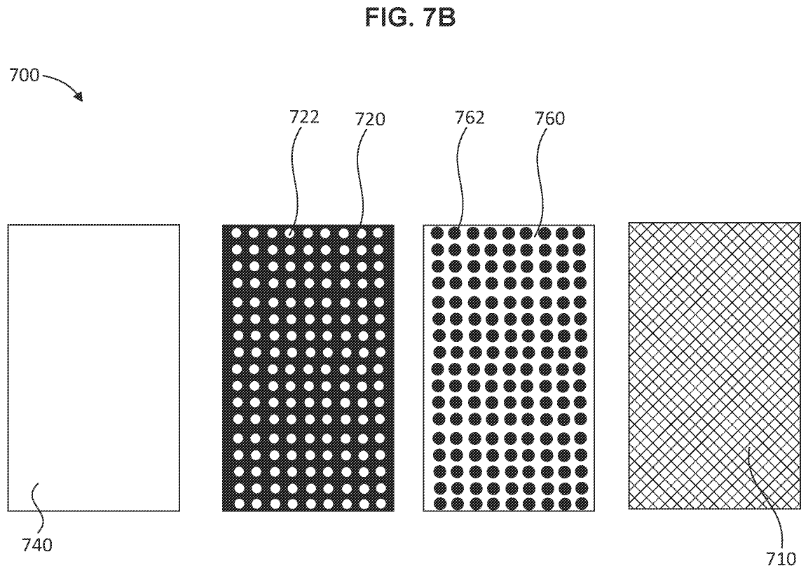

FIGS. 7A-7B are illustrations of an electrode 700 with a current collector reinforcement system, according to an embodiment. FIG. 7A shows a cross-sectional view of the electrode 700 while FIG. 7B shows an exploded view of the components of the electrode 700. As shown, the electrode 700 includes an electrode material 710 disposed on a first side of a current collector 720 with a high-capacity coating 760 positioned between the electrode material 710 and the current collector 720. A film material 740 is disposed on a second side of the current collector 720. The current collector 720 includes holes 722 and the electrode material 710 includes protuberances 711 that penetrate the holes 722. In some embodiments, the electrode material 710, the protuberances 711, the current collector 720, the holes 722, and the film material 740 can be the same or substantially similar to the electrode material 510, the protuberances 511, the current collector 520, the holes 522, and the film material 540, as described above with reference to FIGS. 5A-5B. Thus, certain aspects of the electrode material 710, the protuberances 711, the current collector 720, the holes 722, and the film material 740 are not described in greater detail herein.

In some embodiments, the electrode material 710 can include a semi-solid anode material. In some embodiments, the electrode material 710 can include a semi-solid cathode material. In some embodiments, the electrode material 710 a semi-solid anode material with graphite. In some embodiments, the electrode material 710 can include a graphite-silicon slurry.

As shown, the current collector 720 has an increased thickness, compared to a standard current collector. Also, the current collector 720 is a mesh current collector with holes 722. Together, the thickness of the current collector 720 and the holes 722 can prevent buckling of the current collector 720. In other words, the thickness of the current collector 720 can aid in preventing the current collector 720 from bending, while the holes 722 allow for dispersal of internal stress. In some embodiments, the current collector 720 can be composed of an alloy. In some embodiments, the current collector 720 can include a copper alloy. In some embodiments, the current collector 720 can be a beryllium copper current collector.

In some embodiments, the current collector 720 can have a thickness of at least about 20 μm, at least about 21 μm, at least about 22 μm, at least about 23 μm, at least about 24 μm, at least about 25 μm, at least about 26 μm, at least about 28 μm, at least about 30 μm, at least about 32 μm, at least about 34 μm, at least about 35 μm, at least about 36 μm, at least about 38 μm, at least about 40 μm, at least about 42 μm, at least about 44 μm, at least about 45 μm, at least about 46 μm, at least about 48 μm, at least about 50 μm, at least about 52 μm, at least about 54 μm, at least about 55 μm, at least about 56 μm, or at least about 58 μm. In some embodiments, the current collector 720 can have a thickness of no more than about 60 μm, no more than about 58 μm, no more than about 56 μm, no more than about 55 μm, no more than about 54 μm, no more than about 52 μm, no more than about 50 μm, no more than about 48 μm, no more than about 46 μm, no more than about 45 μm, no more than about 44 μm, no more than about 42 μm, no more than about 40 μm, no more than about 38 μm, no more than about 36 μm, no more than about 35 μm, no more than about 34 μm, no more than about 32 μm, no more than about 30 μm, no more than about 28 μm, no more than about 26 μm, no more than about 25, no more than about 24, no more than about 23, no more than about 22, or no more than about 21. Combinations of the above-referenced thicknesses of the current collector 720 are also possible (e.g., at least about 20 μm and no more than about 60 μm or at least about 40 μm and no more than about 50 μm), inclusive of all values and ranges therebetween. In some embodiments, the current collector 720 can have a thickness of about μm, about 21 μm, about 22 μm, about 23 μm, about 24 μm, about 25 μm, about 26 μm, about 28 μm, about 30 μm, about 32 μm, about 34 μm, about 35 μm, about 36 μm, about 38 μm, about 40 μm, about 42 μm, about 44 μm, about 45 μm, about 46 μm, about 48 μm, about 50 μm, about 52 μm, about 54 μm, about 55 μm, about 56 μm, about 58 μm, or about 60 μm.

In some embodiments, the current collector 720 can have a porosity of at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, or at least about 85%. In some embodiments, the current collector 720 can have a porosity of no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, or no more than about 15%. Combinations of the above-referenced porosity values of the current collector 720 are also possible (e.g., at least about 10% and no more than about 90% or at least about 70% and no more than about 80%), inclusive of all values and ranges therebetween. In some embodiments, the current collector 720 can have a porosity of about 10%, about 15%, about 20%, about 25%, about 30%, about 35%, about 40%, about 45%, about 50%, about 55%, about 60%, about 65%, about 70%, about 75%, about 80%, about 85%, or about 90%.

In some embodiments, the electrode 700 can be an anode and the current collector 720 can be an anode current collector. In some embodiments, the anode current collector can be composed of copper, nickel, stainless steel, titanium, nickel-coated iron, a conductive non-metallic material, carbon nanofiber, or any other suitable material or combinations thereof. In some embodiments, the electrode 700 can be a cathode current collector. In some embodiments, the cathode current collector can include aluminum, stainless steel, gold-coated iron, platinum-coated iron, or any other suitable material or combinations thereof.

The high-capacity coating 760 is coated onto the current collector 720. As shown, the high-capacity coating 760 includes holes 762. In some embodiments, the high-capacity coating 760 can have a similar mesh pattern to the current collector 720. In some embodiments, the high-capacity coating 760 can include silicon. inclusion of the high-capacity coating 760 can effectively make the electrode 700 a multi-layered electrode.

In some embodiments, the high-capacity coating 760 can have a thickness of at least about 500 nm, at least about 600 nm, at least about 700 nm, at least about 800 nm, at least about 900 nm, at least about 1 μm, at least about 1.5 μm, at least about 2 μm, at least about 2.5 μm, at least about 3 μm, at least about 4 μm, at least about 5 μm, at least about 6 μm, at least about 7 μm, at least about 8 μm, at least about 9 μm, at least about 10 μm, at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, at least about 25 μm, at least about 30 μm, at least about 35 μm, at least about 40 μm, at least about 45 μm, at least about 50 μm, at least about 55 μm, at least about 60 μm, at least about 65 μm, at least about 70 μm, or at least about 75 μm. In some embodiments, the high-capacity coating 760 can have a thickness of no more than about 80 μm, no more than about 75 μm, no more than about 70 μm, no more than about 65 μm, no more than about 60 μm, no more than about 55 μm, no more than about 50 μm, no more than about 45 μm, no more than about 40 μm, no more than about 35 μm, no more than about 30 μm, no more than about 25 μm, no more than about 24 μm, no more than about 23 μm, no more than about 22 μm, no more than about 21 μm, no more than about 20 μm, no more than about 19 μm, no more than about 18 μm, no more than about 17 μm, no more than about 16 μm, no more than about 15 μm, no more than about 14 μm, no more than about 13 μm, no more than about 12 μm, no more than about 11 μm, no more than about 10 μm, no more than about 9 μm, no more than about 8 μm, no more than about 7 μm, no more than about 6 μm, no more than about 5 μm, no more than about 4 μm, no more than about 3 μm, no more than about 2 μm, no more than about 1 μm, no more than about 900 nm, no more than about 800 nm, no more than about 700 nm, or no more than about 600 nm.

Combinations of the above-referenced thickness values of the high-capacity coating 760 are also possible (e.g., at least about 500 nm and no more than about 80 μm or at least about 5 μm and no more than about 15 μm, inclusive of all values and ranges therebetween. In some embodiments, the high-capacity coating 760 can have a thickness of about 500 nm, about 600 nm, about 700 nm, about 800 nm, about 900 nm, about 1 μm, about 1.5 μm, about 2 μm, about 2.5 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, about 19 μm, about 20 μm, about 21 μm, about 22 μm, about 23 μm, about 24 μm, about 25 μm, about 30 μm, about 35 μm, about 40 μm, about 45 μm, about 50 μm, about 55 μm, about 60 μm, about 65 μm, about 70 μm, about 75 μm, or about 80 μm.

In some embodiments, the high-capacity coating 760 can be applied to the current collector 720 via a dry coating method. In some embodiments, the dry coating method can include sputtering, plasma, cold spray, electrochemical coating, or any other suitable coating method, or combinations thereof. In some embodiments, the high-capacity coating 760 can be applied to the current collector 720 without the use of a binder. In some embodiments, the high-capacity coating 760 can be applied to the current collector 720 via a wet coating method. In some embodiments, the wet coating can be via dip coating, spray coating, gravure coating, or any other suitable coating method, or combinations thereof. In some embodiments, the wet coating method can include binders.

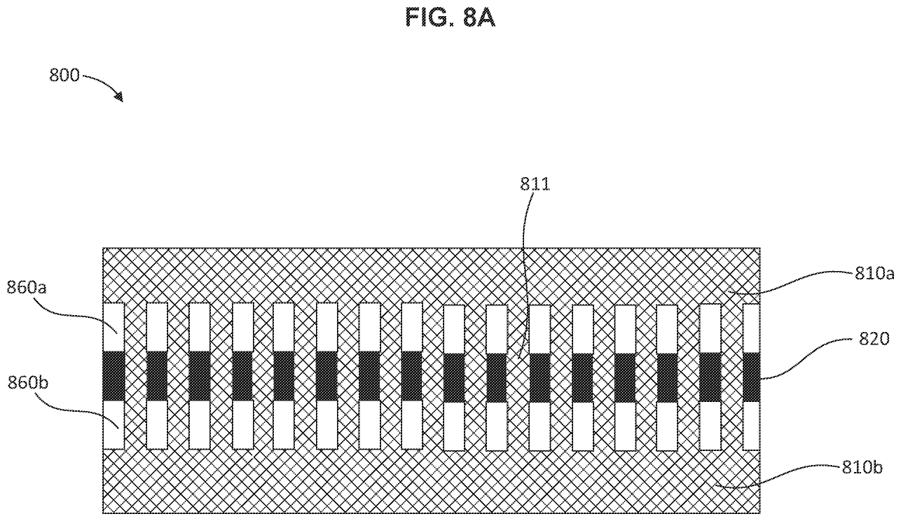

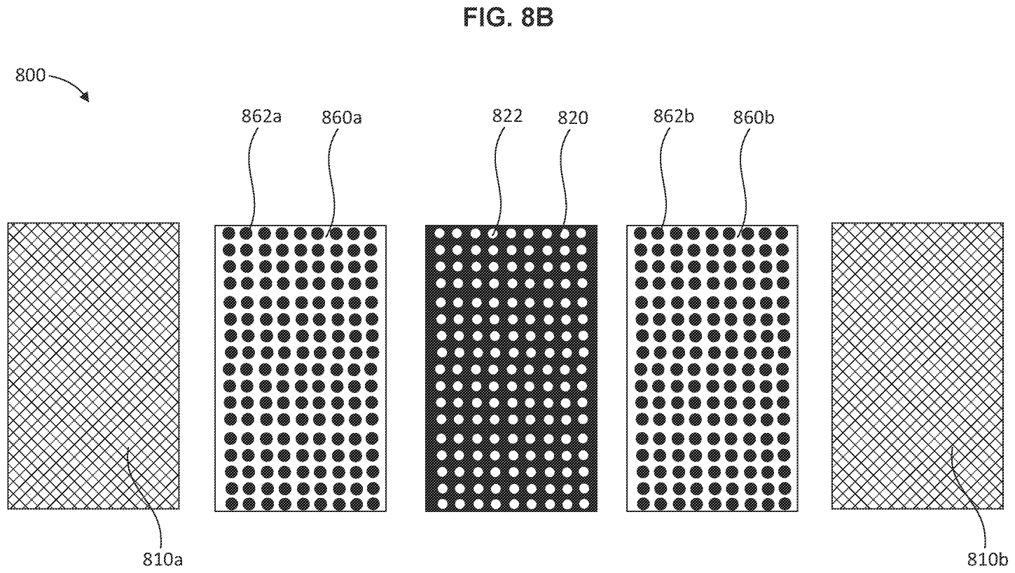

FIGS. 8A-8B are illustrations of an electrode 800 with a current collector reinforcement system, according to an embodiment. FIG. 8A shows a cross-sectional view of the electrode 800 while FIG. 8B shows an exploded view of the components of the electrode 800. As shown, the electrode 800 is a double-sided electrode. As shown, the electrode 800 includes electrode materials 810a, 810b, including protuberances 811, the electrode materials 810a, 810b, disposed on a current collector 820 with holes 822, and high-capacity materials 860a, 860b with holes 862a, 862b. In some embodiments, the electrode materials 810a, 810b, the protuberances 811, the current collector 820, the holes 822, the high-capacity materials 860a, 860b, and the holes 862a, 862b can be the same or substantially similar to the electrode material 710, the protuberances 711, the current collector 720, the holes 722, the high-capacity material 760, and the holes 762, as described above with reference to FIGS. 7A-7B. Thus, certain aspects of the electrode materials 810a, 810b, the protuberances 811, the current collector 820, the holes 822, the high-capacity materials 860a, 860b, and the holes 862a, 862b are not described in greater detail herein.

In some embodiments, the electrode 800 can be incorporated into a bi-cell. In some embodiments, the electrode material 810a can be the same or substantially similar to the electrode material 810b. In some embodiments, the high-capacity material 860a can be the same or substantially similar to the high-capacity material 860b.

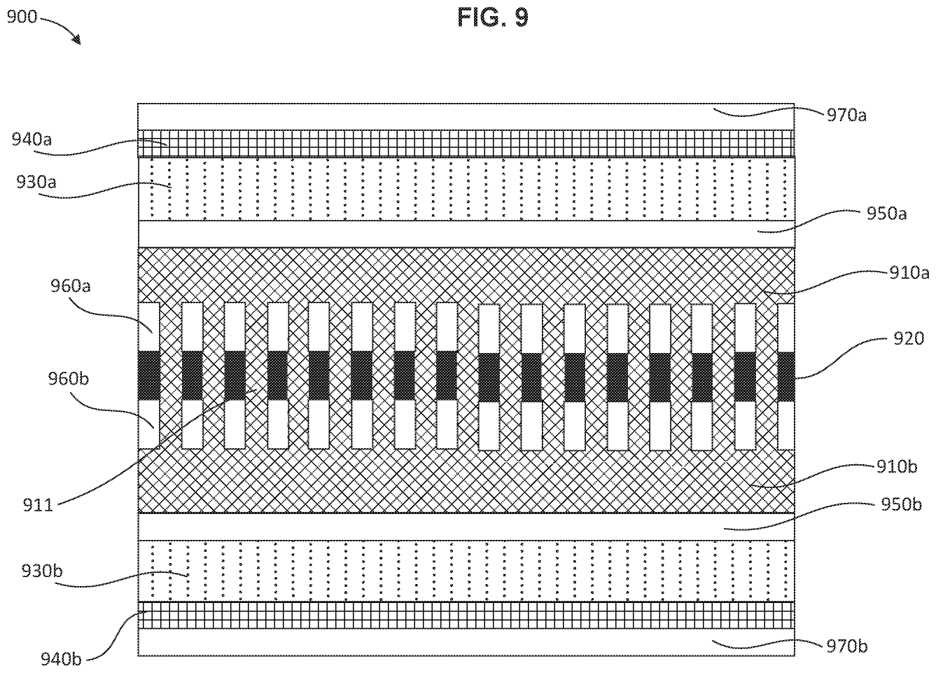

FIG. 9 is an illustration of an electrochemical cell 900 with a current collector reinforcement system, according to an embodiment. As shown, the electrochemical cell 900 is a bi-cell. The electrochemical cell 900 includes anode materials 910a, 910b, including protuberances 911, the anode materials 910a, 910b disposed on an anode current collector 920 with holes 922, high-capacity materials 960a, 960b with holes 962a, 962b, and film materials 970a, 970b. Cathode materials 930a, 930b are disposed on cathode current collectors 940a, 940b, respectively, with a separator 950a disposed between the anode material 910a and the cathode material 930a and a separator 950b disposed between the anode material 910b and the cathode material 930b. In some embodiments, the anode materials 910a, 910b, the protuberances 911, the anode current collector 920, the holes 922, the high-capacity materials 960a, 960b, and the holes 962a, 962b can be the same or substantially similar to the electrode material 810, the protuberances 811, the current collector 820, the holes 822, the high-capacity material 860, and the holes 862, as described above with reference to FIGS. 8A-8B. In some embodiments, the film materials 970a, 970b can be the same or substantially similar to the film material 740, as described above with reference to FIGS. 7A-7B. Thus, certain aspects of the anode materials 910a, 910b, the protuberances 911, the anode current collector 920, the holes 922, the high-capacity materials 960a, 960b, the holes 962a, 962b, and the film materials 970a, 970b are not described in greater detail herein.

As shown, the electrochemical cell 900 is oriented with the anode materials 910a, 910b adjacent to a single anode current collector 920 with the cathode materials 930a, 930b positioned near the outside of the electrochemical cell 900. In some embodiments, the cathode materials 930a, 930b can be positioned adjacent to a central current collector with the anode materials 910a, 910b positioned near the outside of the electrochemical cell 900. In some embodiments, the electrochemical cell 900 can have any of the properties of the electrochemical cells described in U.S. Patent Publication No. 2021/0249695 (“the '695 publication”), filed Feb. 8, 2021, entitled “Divided Energy Electrochemical Cells and Methods of Producing the Same,” the entire disclosure of which is hereby incorporated by reference. In some embodiments, the electrochemical cell 900 can have any of the properties of the electrochemical cells described in U.S. Pat. No. 10,637,038 (“the '038 patent”), filed Nov. 4, 2015, entitled “Electrochemical Cells Having Semi-Solid Electrodes and Methods of Manufacturing the same,” the entire disclosure of which is hereby incorporated by reference.

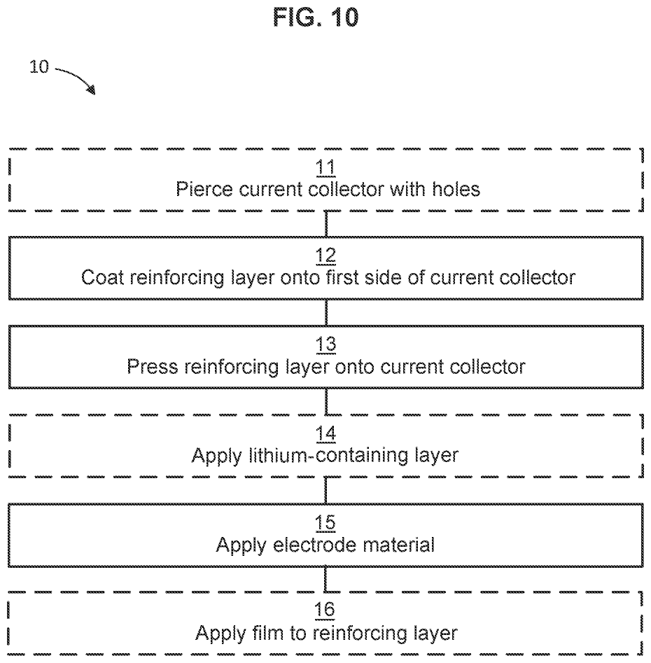

FIG. 10 is a block diagram of a method 10 of producing an electrode with a current collector reinforcement system. As shown, the method 10 optionally includes piercing a current collector with holes at step 11. The method 10 further includes coating a reinforcing layer onto a first side of a current collector at step 12 and pressing the reinforcing layer onto the current collector at step 13. The method 10 optionally includes applying a lithium-containing layer at step 14. The method further includes applying the electrode material at step 15. At step 16, the method 10 optionally includes applying a film to the reinforcing layer.

Piercing the current collector with holes at step 11 can include punching the holes, stamping the holes, drilling the holes, nailing the holes, or any other suitable piercing method or combinations thereof. Any number of holes can be pierced into the current collector. In some embodiments, a single device with multiple piercing apparatus can be employed to pierce the current collector. In some embodiments, a single device can pierce the current collector multiple times. In some embodiments, the device or the piercing apparatus can include a needle. In some embodiments, the holes can be machined into the current collector in a manufacturing process. In other words, the current collector can be fabricated with holes engineered into the current collector. In some embodiments, portions of current collector material removed from the current collector to form the holes can be recycled.

The reinforcing layer is applied to the current collector at step 12. In some embodiments, the reinforcing layer can be laminated to the current collector. In some embodiments, the reinforcing layer can be applied to the same side of the current collector that the piercing apparatus pierced to form the holes. In some embodiments, the reinforcing layer can be applied to the opposite side of the current collector from the side that the piercing apparatus pierced to form the holes. In some embodiments, the reinforcing layer can include binder and/or adhesive for ease of adhering to the current collector.

At step 13, the reinforcing layer is pressed onto the current collector. In some embodiments, the pressing of the reinforcing layer can be sufficient to at least partially push the reinforcing layer through the holes on the current collector. At step 14, a lithium-containing layer is optionally added. In some embodiments, the lithium-containing layer is applied to the current collector. In some embodiments, the lithium-containing layer is applied to an electrode material.

At step 15, the electrode material is added. In some embodiments, the electrode material can be applied to the current collector. In some embodiments, the electrode material can be pressed to the current collector. In some embodiments, the pressing of the electrode material to the current collector can squeeze the electrode material into the holes on the current collector. In some embodiments, the electrode material can be applied to the lithium-containing layer. Step 16 includes optionally applying the film material to the reinforcing layer. The film material can further strengthen the reinforcing material. In some embodiments, the film material can be joined with an additional film material to form a pouch. After the electrode has been formed, the electrode can be coupled to another electrode with a separator disposed therebetween to form an electrochemical cell.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrode, comprising:
a current collector;
an electrode material disposed on a first side of the current collector; and
a reinforcing layer disposed on a second side of the current collector, the reinforcing layer having a modulus of elasticity greater than the modulus of elasticity of the current collector.

2. The electrode of claim 1, further comprising:
a polymer film disposed on a first side of the reinforcing layer, the first side of the reinforcing layer opposite a second surface of the reinforcing layer, the second side of the reinforcing layer coupled to the first side of the current collector.

3. The electrode of claim 1, wherein the electrode includes a polymer adhesive disposed between the reinforcing layer and the current collector.

4. The electrode of claim 3, wherein the polymer adhesive includes at least an elastomer or a crosslinked polymer.

5. The electrode of claim 1, wherein the current collector includes a plurality of holes.

6. The electrode of claim 1, wherein the reinforcing layer includes at least one of sodium silicate, ceramic powder, glass powder, glass fiber, carbon nanotubes, carbon nanofiber, or carbon fiber.

7. The electrode of claim 1, wherein the reinforcing layer has a modulus of elasticity sufficient to reduce the amount of stretching and mechanical stress incident on the current collector during operation of the electrode.

8. The electrode of claim 1, wherein the reinforcing layer has a thickness of less than about 10 μm.

9. The electrode of claim 1, wherein the electrode material is a semi-solid electrode material including an active material and a conductive material in a liquid electrolyte.

10. The electrode of claim 1, wherein the electrode material is an anode material, the electrode further comprising a lithium-containing layer disposed between the current collector and the anode material.

11. An electrode, comprising:
a current collector having a plurality of holes;
an electrode material disposed on the first side of the current collector; and
a reinforcing layer disposed on the second side of the current collector such that the reinforcing layer at least partially fills a void volume created by the plurality of holes in the current collector to form a reinforced current collector,
the reinforcing layer having a modulus of elasticity greater than a modulus of elasticity of the current collector.

12. The electrode of claim 11, further comprising:
a polymer film disposed on a first side of the reinforcing layer, the first side of the reinforcing layer opposite a second side of the reinforcing layer, the second side of the reinforcing layer coupled to the first side of the current collector.

13. The electrode of claim 11, wherein the electrode includes a polymer adhesive disposed between the reinforcing layer and the current collector.

14. The electrode of claim 11, wherein the material for reinforcing layer completely fills the void volume created by the plurality of holes, such that the reinforcing material physically contacts the electrode material.

15. The electrode of claim 11, wherein the reinforcing layer includes at least one of sodium silicate, ceramic powder, glass powder, glass fiber, carbon nanotubes, carbon nanofiber, or carbon fiber.

16. The electrode of claim 11, wherein the reinforced current collector has reduced stretching during electrode operation or mechanical stress compared to the uncoated current collector.

17. The electrode of claim 11, wherein the reinforcing layer has a thickness of less than about 10 μm.

18. The electrode of claim 11, wherein the electrode material is a semi-solid electrode material including an active material and a conductive material in a liquid electrolyte.

19. The electrode of claim 11, wherein the electrode material is an anode material, the electrode further comprising a lithium-containing layer disposed between the current collector and the anode material.

20. A method of forming an electrode:
coating a reinforcing layer onto first side of a current collector, the reinforcing layer having a modulus of elasticity greater than a modulus of elasticity of the current collector;
pressing the reinforcing layer onto the current collector to form a reinforced current collector; and
applying electrode material onto second side of the current collector.

21. The method of claim 20, further comprising:
applying a lithium-containing layer onto the second side of the current collector before applying the electrode material.

22. The method of claim 20, further comprising:
applying a polymer film to a first side of the reinforcing layer, the first side of the reinforcing layer opposite a second side of the reinforcing layer, the second side of the reinforcing layer coupled to the first side of the current collector.

23. The method of claim 20, further comprising:
piercing the current collector to create a plurality of holes before coating reinforcing layer onto the current collector.

24. The method of claim 23, further comprising:
at least partially filling the plurality of holes in the current collector with the reinforcing layer.

25. The method of claim 24, further comprising:
at least partially filling the plurality of holes in current collector with the electrode material such that there is physical contact between the electrode material and the reinforcing layer.

26. The method of claim 20, further comprising:
disposing a polymer adhesive between the current collector and the reinforcing layer.
